(19) United States
(12) Patent Application Publication
(10) Pub. No.: US 2025/0079643 A1
(43) Pub. Date: Mar. 6, 2025

(54) INTEGRATED BATTERY INTERCONNECT ASSEMBLY FOR TRACTION BATTERY ARRAYS

(71) Applicant: FORD GLOBAL TECHNOLOGIES, LLC, Dearborn, MI (US)

(72) Inventors: Francisco FERNANDEZ-GALINDO, Canton, MI (US); Daniel Paul ROBERTS, Livonia, MI (US); Dominic Mario BERTOLINI, Birmingham, MI (US); David DOMAN, Canton, MI (US)

(21) Appl. No.: 18/461,640

(22) Filed: Sep. 6, 2023

(51) Int. Cl. H01M 50/507; H01M 10/48; H01M 50/249; H01M 50/269

(52) U.S. Cl. CPC H01M 50/507; H01M 10/482; H01M 50/249; H01M 50/269; H01M 2220/20

(57) ABSTRACT

Battery arrays are provided for traction battery packs. An exemplary battery array may include an integrated battery interconnect assembly that is configured to electrically connect a plurality of battery cells. The various subcomponents of the integrated battery interconnect assembly may be either preassembled or physically formed together to establish a unitary, integrated component adapted for electrically connecting the battery cells, thereby reducing parts count and complexity.

### TECHNICAL FIELD

This disclosure relates generally to traction battery packs, and more particularly to an integrated battery interconnect assembly for electrically connecting battery cells within a battery array of the traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a plurality of battery cells, and an integrated battery interconnect assembly for electrically connecting the plurality of battery cells. The integrated battery interconnect assembly includes a cell sensing assembly, a top cover secured over top of the cell sensing assembly, and a first bus bar module pivotably connected to the cell sensing assembly. The integrated battery interconnect assembly is movable between a first position in which the first bus bar module is transverse to the top cover and a second position in which the first bus bar module and the top cover establish a substantially flat profile.

In a further non-limiting embodiment of the foregoing battery array, the first position is an assembly position of the integrated battery interconnect assembly, and the second position is a shipping position of the integrated battery interconnect assembly.

In a further non-limiting embodiment of either of the foregoing battery arrays, the cell sensing assembly includes a base positioned over top of the plurality of battery cells and a first bus bar frame mount secured to a bus bar of the first bus bar module.

In a further non-limiting embodiment of any of the foregoing battery arrays, the base is connected to a bus bar frame of the first bus bar module by a clip.

In a further non-limiting embodiment of any of the foregoing battery arrays, the first bus bar frame mount is connected to the base by a first hinge assembly.

In a further non-limiting embodiment of any of the foregoing battery arrays, the first hinge assembly includes a first hinge section connected to the base, a second hinge section connected to the first bus bar module, and a living hinge that movably connects the first hinge section to the second hinge section.

In a further non-limiting embodiment of any of the foregoing battery arrays, the living hinge is established by a thinned section of the first hinge assembly.

In a further non-limiting embodiment of any of the foregoing battery arrays, the first hinge section includes an opening configured to receive a boss of the first bus bar module.

In a further non-limiting embodiment of any of the foregoing battery arrays, a foam barrier is secured to an underside of a base of the cell sensing assembly.

In a further non-limiting embodiment of any of the foregoing battery arrays, the base includes a plurality of vent channels.

A battery array for a traction battery pack according to another exemplary aspect of the present disclosure includes, among other things, a plurality of battery cells, and an integrated battery interconnect assembly for electrically connecting the plurality of battery cells. The integrated battery interconnect assembly includes a first bus bar module, a second bus bar module, a cell sensing assembly that extends between the first bus bar module and the second bus bar module, and a top cover positioned over top of the cell sensing assembly.

In a further non-limiting embodiment of the foregoing battery array, the cell sensing assembly includes a base that extends between the first bus bar module and the second bus bar module, a first bus bar frame mount secured to a first bus bar of the first bus bar module, and a second bus bar frame mount secured to a second bus bar of the second bus bar module.

In a further non-limiting embodiment of either of the foregoing battery arrays, the first bus bar is held within a first bus bar frame of the first bus bar module, and the second bus bar is held within a second bus bar frame of the second bus bar module.

In a further non-limiting embodiment of any of the foregoing battery arrays, the base of the cell sensing assembly is connected to the first bus bar frame by a first clip and to the second bus bar frame by a second clip.

In a further non-limiting embodiment of any of the foregoing battery arrays, the first bus bar frame mount is connected to the base by a first hinge assembly, and the second bus bar frame mount is connected to the base by a second hinge assembly.

In a further non-limiting embodiment of any of the foregoing battery arrays, each of the first hinge assembly and the second hinge assembly includes a first hinge section connected to the base, a second hinge section connected to the first bus bar module or the second bus bar module, and a living hinge that movably connects the first hinge section to the second hinge section.

In a further non-limiting embodiment of any of the foregoing battery arrays, the living hinge is established by a thinned section of the first hinge assembly or the second hinge assembly.

In a further non-limiting embodiment of any of the foregoing battery arrays, the first hinge section includes an opening configured to receive a boss of the first bus bar module or the second bus bar module.

In a further non-limiting embodiment of any of the foregoing battery arrays, a foam barrier is secured to an underside of a base of the cell sensing assembly.

In a further non-limiting embodiment of any of the foregoing battery arrays, the base includes a plurality of vent channels.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 illustrates the battery array of FIG. 2 with portions of an integrated battery interconnect assembly removed for illustrating select internal components of the battery array.

FIG. 4 illustrates an assembly position of an integrated battery interconnect assembly of a battery array.

FIG. 5 illustrates a shipping position of the integrated battery interconnect assembly of FIG. 4.

FIG. 6 is an exploded view of the integrated battery interconnect assembly of FIG. 4.

FIG. 7 schematically illustrates the positioning of an integrated battery interconnect assembly relative to a cell stack of battery cells.

FIG. 8 is a blown-up view of area 8 of FIG. 4.

FIG. 9 is a blown-up view of area 9 of FIG. 8.

### DETAILED DESCRIPTION

This disclosure details battery arrays for traction battery packs. An exemplary battery array may include an integrated battery interconnect assembly that is configured to electrically connect a plurality of battery cells. The various subcomponents of the integrated battery interconnect assembly may be either preassembled or physically formed together to establish a unitary, integrated component adapted for electrically connecting the battery cells, thereby reducing parts count and complexity. These and other features are discussed in greater detail in the following paragraphs of this detailed description.

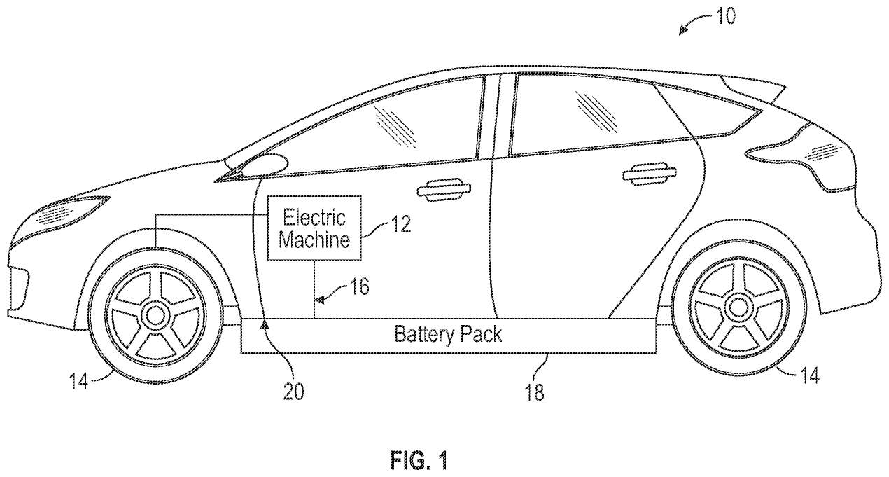

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

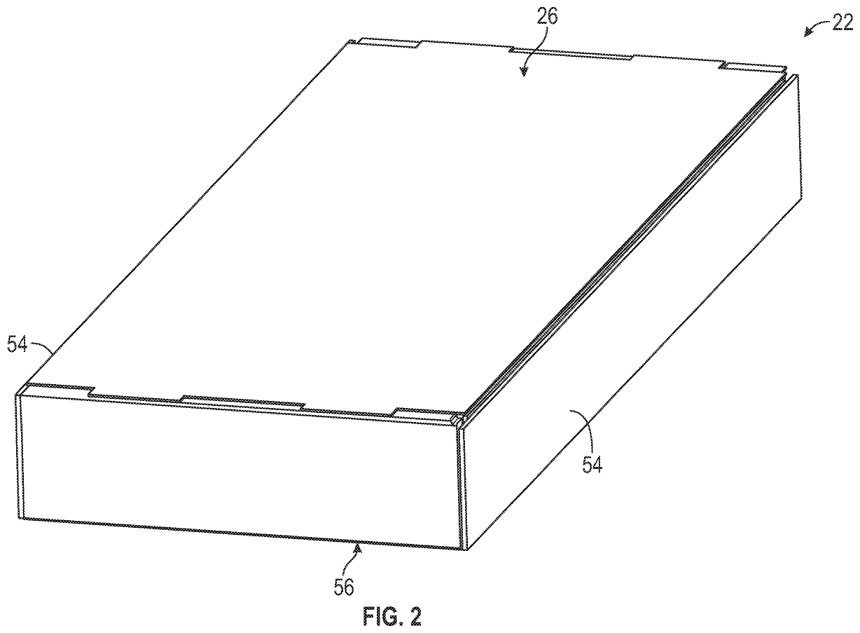

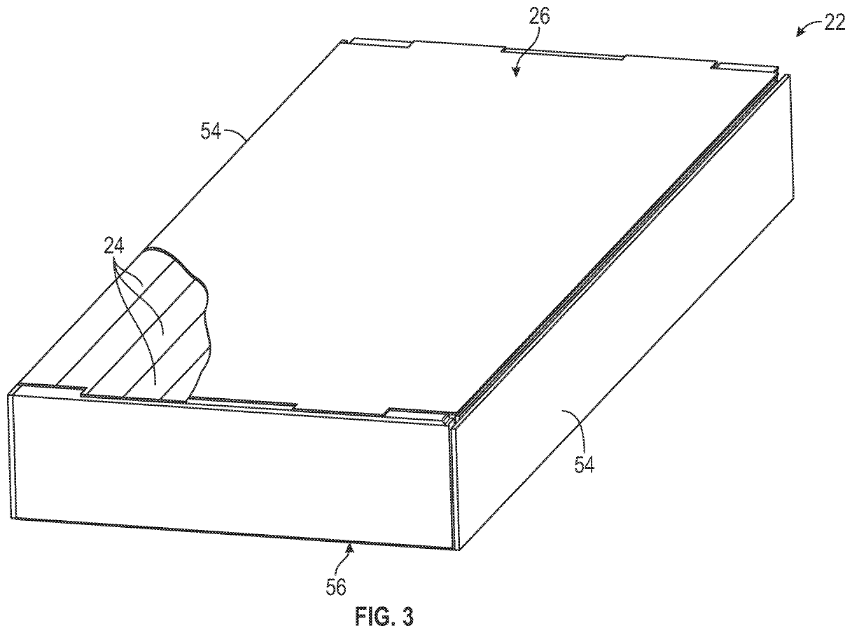

FIGS. 2 and 3 illustrate an exemplary battery array 22 for a traction battery pack, such as the traction battery pack 18 of FIG. 1, for example. One or more battery arrays having a design similar to the battery array 22 shown in FIGS. 2-3 could be packaged within the traction battery pack 18.

The battery array 22 may include a plurality of battery cells 24 (see cutaway portion of FIG. 3). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be stacked side-by-side along a stack axis to construct a grouping of battery cells 24, sometimes referred to as a “cell stack.” The cell stack may be grouped into two or more cell banks, although the exact configuration of the cell stack of battery cells 24 is not intended to limit this disclosure.

The battery array 22 may additionally include an integrated battery interconnect assembly 26. Among other functions, the integrated battery interconnect assembly 26 may electrically connect the battery cells 24 of the cell stack. Once electrically coupled, the battery cells 24 may supply at least a portion of the electrical power necessary for achieving electric propulsion of the electrified vehicle 10.

As explained in further detail below, the various subcomponents of the integrated battery interconnect assembly 26 may be integrated together to reduce parts and provide an optimized packaging configuration of the battery array 22. In this disclosure, the term “integrated” means that the various subcomponents of the integrated battery interconnect assembly 26 are either preassembled (snapped, clipped, bolted, etc.) or physically formed together to establish a unitary, integrated component.

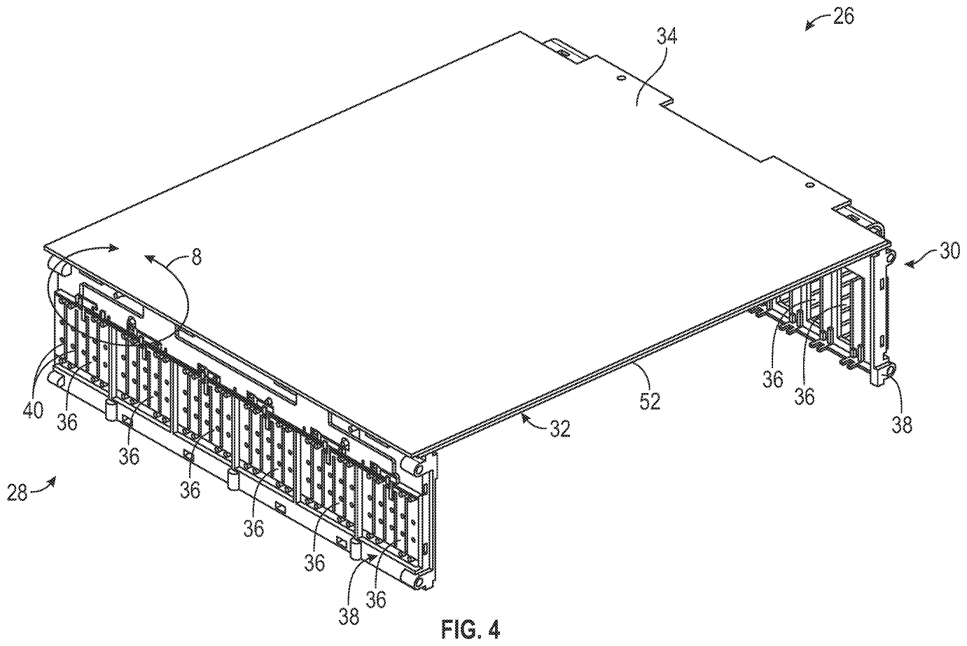

FIGS. 4, 5, and 6 further illustrate the integrated battery interconnect assembly 26 of the battery array 22. The integrated battery interconnect assembly 26 may include a first bus bar module 28, a second bus bar module 30, a cell sensing assembly 32, and a top cover 34.

The first bus bar module 28 and the second bus bar module 30 may each include a plurality of bus bars 36 held within a bus bar frame 38. The total number of bus bars 36 provided within each of the first bus bar module 28 and the second bus bar module 30 is not intended to limit this disclosure.

The bus bars 36 may be metallic components of the first and second bus bar modules 28, 30, and the bus bar frames 38 may be plastic components of the first and second bus bar modules 28, 30. In an embodiment, the bus bars 36 are made of copper or aluminum, and the bus bar frames 38 are made of polypropylene or polyethylene. However, other materials are contemplated within the scope of this disclosure

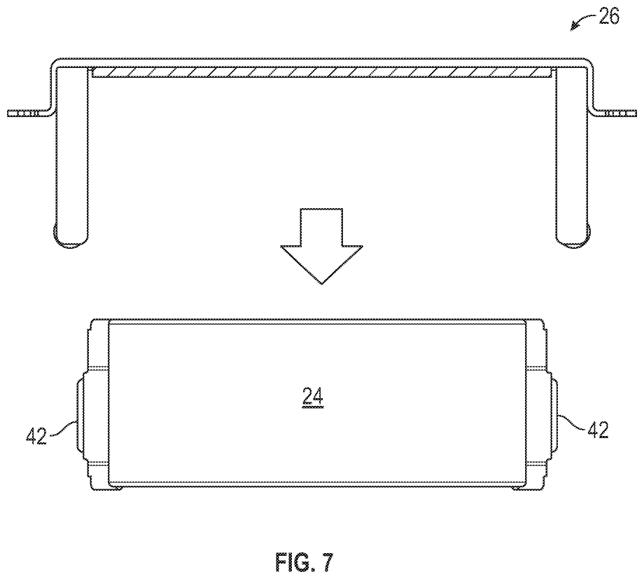

Each bus bar 36 may include openings 40 (e.g., elongated slots) that are each sized for receiving a cell tab terminal 42 of one of the battery cells 24 of the cell stack (see, e.g., FIG. 7). The cell tab terminals 42 may extend through the openings 40 such that at least a portion of each cell tab terminal 42 is located on an opposite side of the bus bar 36 from its respective battery cell 24. The tab terminals 42 of adjacent battery cells 24 may then be joined together for electrically connecting the battery cells 24 of the battery array 22 to one another.

The cell sensing assembly 32 may include sense leads and other circuitry necessary for monitoring voltage and temperature information associated with the battery cells 24 of the battery array 22. The cell sensing assembly 32 may include a base 44, a first bus bar frame mount 46 integrally formed at a first side of the base 44, and a second bus bar frame mount 48 integrally formed at a second side of the base 44.

A plurality of vent channels 50 may be formed through the base 44. The vent channels 50 may be arranged to permit battery cell vent gases to pass through the cell sensing assembly 32, such as during a battery thermal event, for example, when the battery array 22 is fully assembled.

The cell sensing assembly 32 may additionally include a foam barrier 52. The foam barrier 52 may be secured to or integrally formed with an underside of the base 44 and may be configured to protect various circuitry of the cell sensing assembly 32, such as from the heat generated within the battery cells 24, for example.

The base 44 of the cell sensing assembly 32 may be secured to or integrally formed with an underside of the top cover 34 of the integrated battery interconnect assembly 26. The battery cells 24 of the battery array 22 may be substantially enclosed by the integrated battery interconnect assembly 26, a pair of end plates 54, and a bottom cover 56 (see FIGS. 2 and 3). The integrated battery interconnect assembly 26 may thus provide part of (here, the lid or cover) an array housing of the battery array 22. The integrated battery interconnect assembly 26 can therefore be used in place of a separate array housing cover, thereby reducing overall part counts and complexity. When the battery array 22 is fully assembled, the top cover 34 and the bottom cover 56 may cooperate to substantially cover the first and second bus bar modules 28, 30 of the integrated battery interconnect assembly 26.

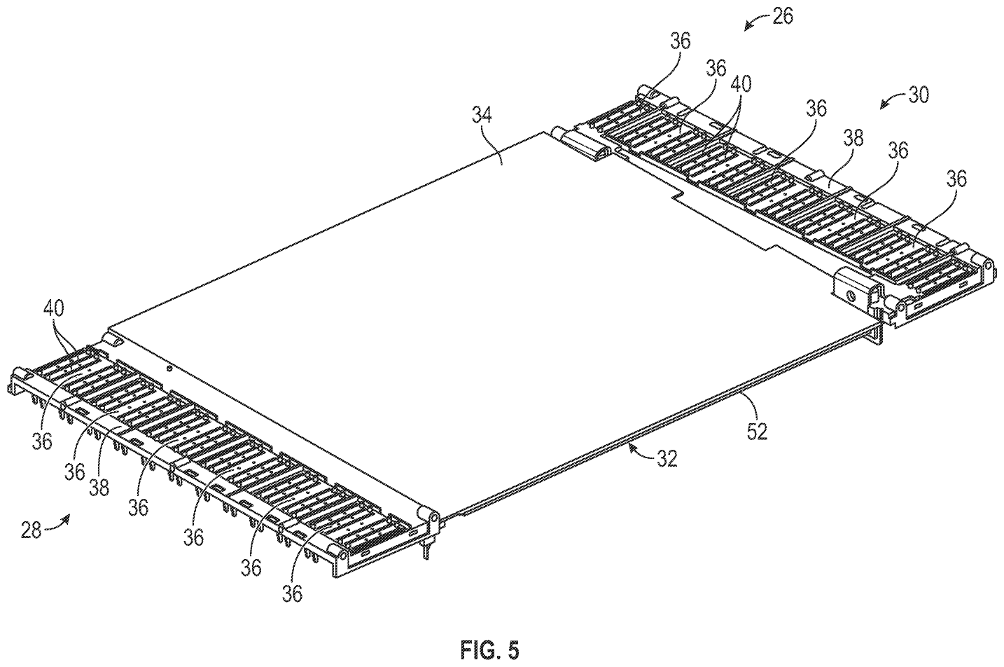

The integrated battery interconnect assembly 26 may be configurable between a first or assembly position (see FIG. 4) and a second or shipping position (see FIG. 5). In the assembly position, the first and second bus bar modules 28, 30 extend along axes that are transverse (e.g., about perpendicular) to the top cover 34 to define a “U” shaped profile. In this position, the integrated battery interconnect assembly 26 can be positioned relative to and then secured to the battery cells 24.

In the shipping position, the first and second bus bar modules 28, 30 and the top cover 34 are disposed along a common plane such that the integrated battery interconnect assembly 26 defines a substantially flat profile. In this position, the integrated battery interconnect assembly 26 can be more easily handled for shipping, etc.

The integrated battery interconnect assembly 26 may be transitioned between the assembly position of FIG. 4 and the shipping position of FIG. 5 by pivoting the first and second bus bar modules 28, 30 relative to the top cover 34. The pivoting motion can be achieved via a plurality of hinge assemblies 58. The hinge assemblies 58 may be integrated as part of the cell sensing assembly 32. In the illustrated embodiment, the cell sensing assembly 32 includes a total of four hinge assemblies 58. However, a greater or fewer number of hinge assemblies 58 may be provided within the scope of this disclosure.

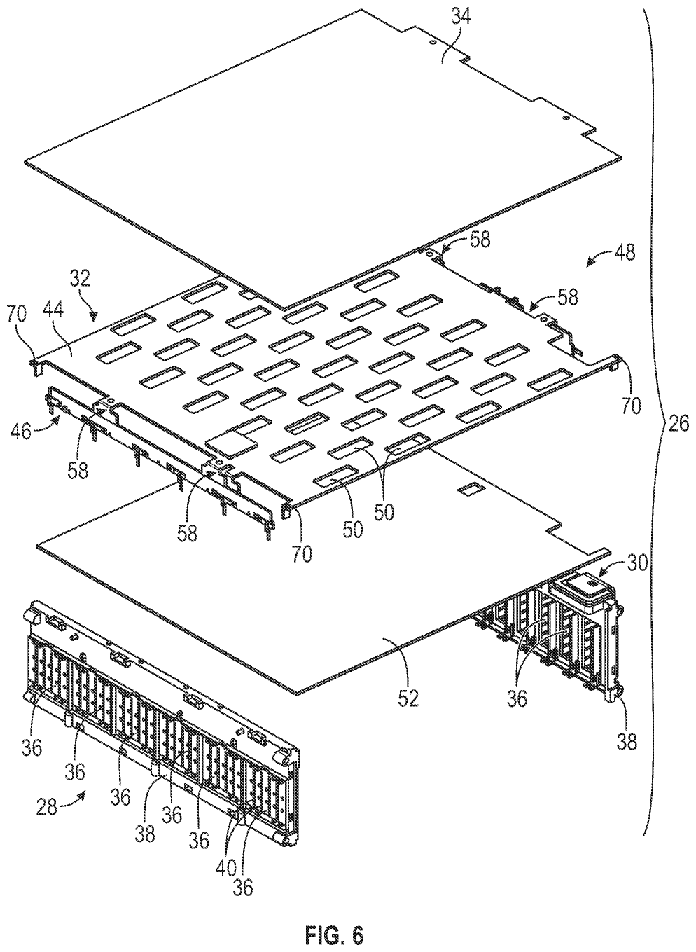

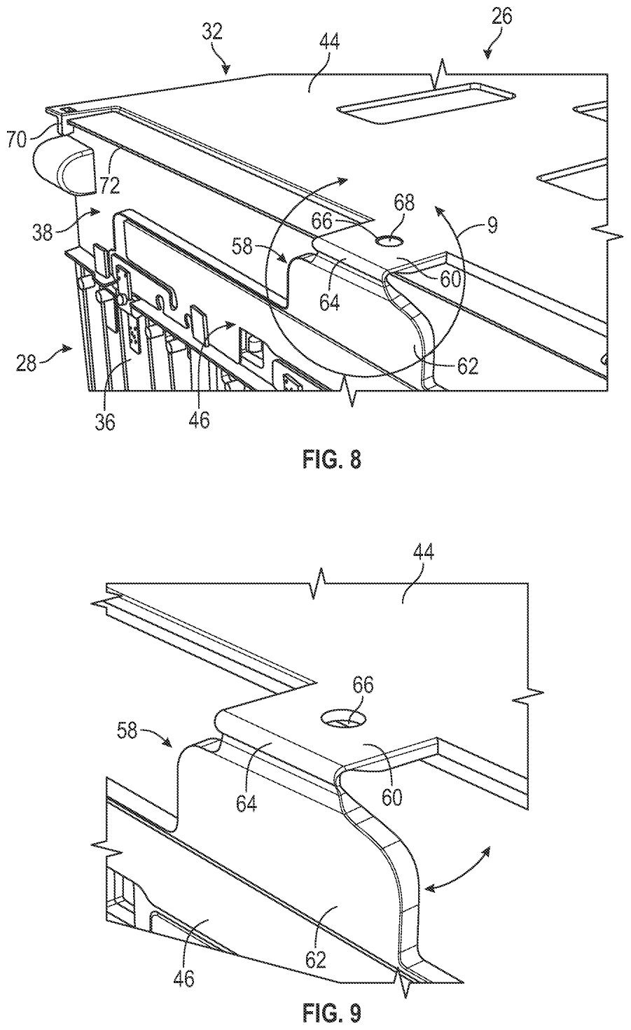

Referring now primarily to FIGS. 6, 8, and 9, each hinge assembly 58 of the integrated battery interconnect assembly 26 may include a first hinge section 60, a second hinge section 62, and a living hinge 64 that movably connects the first hinge section 60 to the second hinge section 62. Notably, the top cover 34 is removed in FIGS. 8 and 9 for better illustrating the features of the hinge assemblies 58.

The first hinge section 60 may be integrally formed with or otherwise connected to the base 44 of the cell sensing assembly 32, and the second hinge section 62 may be integrally formed with or otherwise connected to either the first bus bar frame mount 46 or the second bus bar frame mount 48 of the cell sensing assembly 32. Further, the first bus bar frame mount 46 may be mounted to one or more bus bars 36 of the first bus bar module 28, and the second bus bar frame mount 48 may be mounted to one or more bus bars 36 of the second bus bar module 30.

The living hinge 64 may be a thinned portion of the hinge assembly 58 that allows the second hinge section 62 to be pivoted relative to the first hinge section 60, thereby providing the ability to alter the position of the first bus bar frame mount 46 or the second bus bar frame mount 48 relative to the base 44. Since the first bus bar frame mount 46 can be mounted to the first bus bar module 28 and the second bus bar frame mount 48 can be mounted to the second bus bar module 30, the hinge assemblies 58 can facilitate pivotable movement of the first and second bus bar modules 28, 30 relative to the top cover 34. The hinge assemblies 58 may therefore enable the integrated battery interconnect assembly 26 to be easily transitioned between the assembly position of FIG. 4 and the shipping position of FIG. 5.

The cell sensing assembly 32 may additionally include features for establishing a connection between the cell sensing assembly 32 and each of the first bus bar module 28 and the second bus bar module 30. For example, the first hinge section 60 of each hinge assembly 58 may include an opening 66 that is configured to receive a boss 68 of the bus bar frame 38 of the first bus bar module 28 or the second bus bar module 30 in order to locate and secure the cell sensing assembly 32 relative to the first bus bar module 28 or the second bus bar module 30. Further, the base 44 of the cell sensing assembly 32 may include a plurality of clips 70 that are configured to snap connect to an upper flange 72 of the bus bar frame 38 of either the first bus bar module 28 or the second bus bar module 30. The cell sensing assembly 32 (and thus the top cover 34 once secured over top of the base 44) may thus be integrated together with the first bus bar module 28 and the second bus bar module 30.

The exemplary battery arrays of this disclosure include integrated battery interconnect assemblies for electrically connecting a stacked grouping of battery cells. The subcomponents of the integrated battery interconnect assembly are integrated together to reduce parts and provide for optimized array packaging.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a plurality of battery cells; and
an integrated battery interconnect assembly for electrically connecting the plurality of battery cells, the integrated battery interconnect assembly including a cell sensing assembly, a top cover secured over top of the cell sensing assembly, and a first bus bar module pivotably connected to the cell sensing assembly,
wherein the integrated battery interconnect assembly is movable between a first position in which the first bus bar module is transverse to the top cover and a second position in which the first bus bar module and the top cover establish a substantially flat profile.

2. The battery array as recited in claim 1, wherein the first position is an assembly position of the integrated battery interconnect assembly and the second position is a shipping position of the integrated battery interconnect assembly.

3. The battery array as recited in claim 1, wherein the cell sensing assembly includes a base positioned over top of the plurality of battery cells and a first bus bar frame mount secured to a bus bar of the first bus bar module.

4. The battery array as recited in claim 3, wherein the base is connected to a bus bar frame of the first bus bar module by a clip.

5. The battery array as recited in claim 3, wherein the first bus bar frame mount is connected to the base by a first hinge assembly.

6. The battery array as recited in claim 5, wherein the first hinge assembly includes a first hinge section connected to the base, a second hinge section connected to the first bus bar module, and a living hinge that movably connects the first hinge section to the second hinge section.

7. The battery array as recited in claim 6, wherein the living hinge is established by a thinned section of the first hinge assembly.

8. The battery array as recited in claim 6, wherein the first hinge section includes an opening configured to receive a boss of the first bus bar module.

9. The battery array as recited in claim 1, comprising a foam barrier secured to an underside of a base of the cell sensing assembly.

10. The battery array as recited in claim 9, wherein the base includes a plurality of vent channels.

11. A battery array for a traction battery pack, comprising:
a plurality of battery cells; and
an integrated battery interconnect assembly for electrically connecting the plurality of battery cells, the integrated battery interconnect assembly including:
a first bus bar module;
a second bus bar module;
a cell sensing assembly that extends between the first bus bar module and the second bus bar module; and
a top cover positioned over top of the cell sensing assembly.

12. The battery array as recited in claim 11, wherein the cell sensing assembly includes a base that extends between the first bus bar module and the second bus bar module, a first bus bar frame mount secured to a first bus bar of the first bus bar module, and a second bus bar frame mount secured to a second bus bar of the second bus bar module.

13. The battery array as recited in claim 12, wherein the first bus bar is held within a first bus bar frame of the first bus bar module, and the second bus bar is held within a second bus bar frame of the second bus bar module.

14. The battery array as recited in claim 13, wherein the base of the cell sensing assembly is connected to the first bus bar frame by a first clip and to the second bus bar frame by a second clip.

15. The battery array as recited in claim 12, wherein the first bus bar frame mount is connected to the base by a first hinge assembly, and the second bus bar frame mount is connected to the base by a second hinge assembly.

16. The battery array as recited in claim 15, wherein each of the first hinge assembly and the second hinge assembly includes a first hinge section connected to the base, a second hinge section connected to the first bus bar module or the second bus bar module, and a living hinge that movably connects the first hinge section to the second hinge section.

17. The battery array as recited in claim 16, wherein the living hinge is established by a thinned section of the first hinge assembly or the second hinge assembly.

18. The battery array as recited in claim 16, wherein the first hinge section includes an opening configured to receive a boss of the first bus bar module or the second bus bar module.

19. The battery array as recited in claim 11, comprising a foam barrier secured to an underside of a base of the cell sensing assembly.

20. The battery array as recited in claim 19, wherein the base includes a plurality of vent channels.
